(19) United States
(12) Patent Application Publication
(10) Pub. No.: US 2002/0160079 A1
(43) Pub. Date: Oct. 31, 2002

(54) Koji produced from soybean hypocotyl, preparation method thereof, and soy hypocotyl products prepared from said koji

(76) Inventors: Tae-Hyun Kim, Cheonan-si (KR); Myoung-Gyu Park, Cheonan-si (KR); Eun-Ju Kim, Cheonan-si (KR); Kee-Sun Yoon, Suwon-si (KR)

Correspondence Address: David A. Einhorn, Esq., Anderson Kill & Olick, P.C., 1251 Avenue of the Americas, New York, NY, 10020, US

(21) Appl. No.: 10/087,705

(22) Filed: Feb. 28, 2002

(30) Foreign Application Priority Data
Feb. 28, 2001 (KR) 2001-10233
Nov. 15, 2001 (KR) 2001-70978

(51) Int. Cl. A23G 1/02

(52) U.S. Cl. 426/44

(57) ABSTRACT

Koji is produced from soybean hypocotyl as a koji substrate by: (a) soaking the soybean hypocotyl in water for a period ranging from 1 min to 30 hrs; (b) steaming the soaked soybean hypocotyl at a temperature ranging from 90 to 140° C.; (c) inoculating Bacillus sp., Aspergilllus sp or a mixture thereof to the steamed soybean hypocotyl in an amount ranging from 0.01 to 10 wt % based on the total weight of the soybean hypocotyl; and (d) culturing the inoculated soybean hypocotyl at a temperature ranging from 15 to 55° C., a relative humidity ranging from 40 to 100% and at a pH ranging from 3 to 10 for a period ranging from 1 to 8 days.

### FIELD OF THE INVENTION

The present invention relates to a method of preparing soybean hypocotyl koji containing a large quantity of isoflavone, the soybean hypocotyl koji prepared therefrom, and fermented soy hypocotyl products prepared from the soybean hypocotyl koji.

### BACKGROUND OF THE INVENTION

Fermented soybean products, e.g., soy sauce, soybean paste and pepper soypaste, are consumed in large quantities in Korea, Japan, China, Southeast Asia and in other parts of the world. It has been found that such soy products contain high levels of unsaturated fatty acids and free amino acids, e.g., glutamic acid and leucine, and are effective in preventing various diseases, e.g., osteoporosis.

A fermented soybean product is normally required to have a good and sweet taste. A good taste is exerted by digesting proteins into amino acid components with protease, and a sweet taste, by converting starch into glucose by the action of amylase. Therefore, it is necessary for the microorganisms used in preparing such fermented soybean products to have the capability of producing protein- and starch-degrading enzymes.

Koji is a koji mold preparation which plays the role of producing and accumulating enzymes such as amylase and protease by the action of koji microorganism. Further, it is a source of supply for amylase and protease, and provides various nutrients for stimulating yeast reproduction and fermentation. Koji is prepared by the fermenting action of koji mold on starch-containing grains, e.g., polished rice, barley, wheat, wheat flour, rye, wheat corn, bran, scoured barley, pressed barley, crushed rice or glutinous rice, and protein-containing grains, e.g., leguminous plants, defatted soybeans or defatted soybean flour. A good quality koji preparation contains copious amounts of koji mold and enzymes for preparing fermented soybean products and is free of various contaminant bacteria which cause foul smell.

Isoflavone is a natural compound that has high affinity to estrogen receptors in living body and acts as an agonist or antagonist of estrogen depending on the hormone concentration or target tissue. It has recently been discovered that isoflavone has significant effects in preventing osteoporosis, various chronic diseases, and prostate cancer, as well as antioxidant and aldehyde dehydrogenase inhibitory activities.

Most isoflavone isomers exist in the form of glycoside, while some isomers, in the form of aglycone. Since the glycoside type is degraded only by β-glucosidase excreted from intestinal bacteria and not by gastric acid, it shows a low internal absorption rate. However, the latter aglycone type can be readily absorbed in the small intestine and stomach.

Since soybean hypocotyl is a by-product produced in the process of preparing soymilk or soy oil, it usually goes to waste. Soybean hypocotyl is similar to soybean in terms of constituents. That is, soybean hypocotyl typically consists of: 43.4% of crude protein, 11.5% of crude fatty acid, 38.1% of soluble carbohydrate, 2.8% of crude fiber and 4.3% of ash; whereas soybean may consist of: 42.6% of crude protein, 21.4% of crude fatty acid, 26.2% of soluble carbohydrate, 4.7% of crude fiber and 5.0% of ash. Accordingly, soybean hypocotyl can be a low cost substitute for soybean. The use of soybean hypocotyl is advantageous in that while the isoflavone content of soybean is only 0.3 wt %, the isoflavone content of soybean hypocotyl is much higher at 2˜3 wt %.

The present inventors have therefore endeavored to develop koji containing a high level of isoflavone, especially in the form of aglycone, using soybean hypocotyl as a raw material.

### SUMMARY OF THE INVENTION

Accordingly, it is a primary object of the present invention to provide a method for producing koji from soybean hypocotyl and the koji prepared thereby.

It is another object of the present invention to provide a method for manufacturing fermented soy hypocotyl products such as soybean hypocotyl paste and soy hypocotyl sauce having high isoflavone and aglycone isoflavone contents.

In accordance with the present invention, there is provided a method for producing koji comprising: (a) soaking soybean hypocotyl in water for a period ranging from 1 min to 30 hrs; (b) steaming the soaked soybean hypocotyl at a temperature ranging from 90 to 140° C.; (c) inoculating the steamed soybean hypocotyl with Bacillus sp., Aspergilllus sp. or a mixture thereof in an amount ranging from 0.01 to 10 wt % based on the weight of the soybean hypocotyl; and (d) culturing the inoculated soybean hypocotyl at a temperature ranging from 15 to 55° C., a relative humidity ranging from 40 to 100% and at a pH ranging from 3 to 10 for a period ranging from 1 to 8 days.

The above and other objects and features of the present invention will become apparent from the following description of the invention.

### DETAILED DESCRIPTION OF THE INVENTION

The present invention relates to isoflavone-containing koji produced from soybean hypocotyl and a method for the manufacture thereof, comprising: culturing soybean hypocotyl inoculated with Bacillus sp. or Aspergillus sp. or a mixture thereof in an amount of 0.01 to 10% by weight based on the weight of the hypocotyl, and a fermented soy hypocotyl product produced using said koji. Bacillus sp. and Aspergillus sp. are well known to have the ability to produce protease and amylase.

In accordance with one aspect of the present invention, there is provided a method for preparing soybean hypocotyl koji, comprising: soaking soybean hypocotyl for 1 min to 30 hours, preferably 5 min to 10 hrs, more preferably 1 to 30 min; steaming the soaked soybean hypocotyl at 90 to 140° C., preferably at 110 to 120° C., followed by cooling; inoculating the cooled soybean hypocotyl with Bacillus sp., Aspergillus sp. or a mixture thereof in an amount of 0.01 to 10% by weight, preferably 0.1 to 5%; and cultivating the inoculated soybean hypocotyl at 15 to 55° C., preferably 32 to 43° C., more preferably 25 to 35° C., under a relative humidity of 40 to 100%, preferably 80 to 99%, and pH 3 to 10 for 1 to 8 days, preferably 3 to 5 days, more preferably 12 to 72 hours, to obtain the soybean hypocotyl koji.

The Bacillus sp. which can be used in the present invention is selected from the group consisting of Bacillus brevis, Bacillus licheniformis, Bacillus natto, Bacillus polymixa, Bacillus pumilis, Bacillus subtilis and a mixture thereof.

Any of Aspergillus sp. generally used in the art may be used in the present invention, and examples thereof are Aspergillus awamori, Aspergillus kawachii, Aspergillus niger, Aspergillus oryzae, Aspergillus shirousamii, Aspergillus sojae, Aspergillus tamarii and a mixture thereof.

According to the method of the present invention, the soybean hypocotyl koji may contain soybean hypocotyl in an amount of 5 to 100 wt %.

The present invention also provides a fermented soy hypocotyl product produced using the inventive soybean hypocotyl koji, examples of the fermented soy hypocotyl product being soybean hypocotyls paste, soy hypocotyl sauce or pepper soypaste.

The present invention also provides a preparation method of said fermented soy hypocotyl product, which comprises: (a) inoculating yeast or lactic acid bacteria to the inventive soybean hypocotyl koji described above; (b) adding refined salt and sterile water thereto; (c) cultivating the resulting mixture at 15 to 55° C. and 40 to 90% relative humidity for 25 to 360 days.

In step (a) of the above method, yeast or lactic acid bacteria may be added in an amount of 0.01 to 10 wt %, preferably 0.1 to 5 wt % based on the weight of the fermented soy hypocotyl product.

In step (b), refined salt and sterile water may be added in an amount of 1 to 40 wt % and 0 to 40 wt %, respectively, preferably 5 to 25 wt % and 0.5 to 2 wt %, respectively, based on the total weight of the fermented soy hypocotyl product.

Step (c) is preferably performed at 25 to 35° C. and 70 to 80% relative humidity for 90 to 120 days.

In the inventive process of preparing a fermented soy hypocotyl product, yeast or lactic acid bacteria is added in an amount of 0.01 to 10 wt % based on the weight of the product as an added ingredient that can improve the taste of the fermented soy hypocotyl product. Any of the yeasts generally used in the art, e.g., Saccharomyces rouxii, Torulopsis dattila, Torulopsis etcbellsii, Torulopsis versatilis, Zygosaccharomyces rouxii and a mixture thereof, may be used in the present invention. Examples of the lactic acid bacteria which can be used in the present invention are Pediococcus halphilus, Pediococcus sojae, Tetracoccus sojae and a mixture thereof.

The inventive fermented soy hypocotyl product may be produced from soybean hypocotyl koji alone; a mixture of soybean hypocotyl koji and starch koji; or a mixture of starch koji and steamed soybean hypocotyl.

In the process of preparing a soybean paste from a mixed koji substrate, e.g., a mixture of soybean hypocotyl koji and starch koji or a mixture of starch koji and steamed soybean hypocotyl, the former and the latter may be used in the respective amounts of 5 to 97 wt % and 1 to 95 wt %, based on the total weight of the soybean paste, preferred being 20 to 55 wt % and 25 to 70 wt %.

The starch koji used in the present method can be produced from polished rice, barley, wheat, wheat flour, rye, wheat bran, scoured barley, pressed barley, crushed rice, glutinous rice or a mixture thereof, using the same process for manufacturing the inventive soybean hypocotyl koji described above.

In another preferred embodiment of the present invention, a pepper soypaste is produced from the soybean hypocotyl koji by a process, wherein powdered red pepper is further included in an amount of 1 to 40 wt % based on the weight of the pepper soypaste in the step of adding refined salt and sterile water during the above-mentioned process for preparing of a soybean paste.

In a further preferred embodiment of the present invention, a preparation method of a soybean hypocotyl koji-derived soy sauce is provided, which comprises: drying the inventive soybean hypocotyl koji at 40 to 90° C., preferably 55 to 65° C. for 12 to 72 hrs, preferably 24 to 48 hrs; adding a brine having a salt level of 10 to 70%, preferably 15 to 25%, in an amount in the range of 2 to 10 times, preferably 2 to 4 times the weight of the dried koji; and aging at 10 to 50° C., preferably 15 to 25° C., for 10 to 50 days, preferably 25 to 35 days. The soy sauce may be further aged at 10 to 50° C., preferably 15 to 25° C. for 10 to 50 days, preferably 25 to 35 days, for the purpose of improving the flavor.

Further, a soybean paste can be produced from koji residue, a byproduct produced during the manufacturing process of the hypocotyl koji-derived soy sauce of the present invention. The soybean paste manufactured by the method of the present invention contains isoflavone or aglycone isoflavone in an amount of 0.1 to 3 wt %, based on the total weight of the soybean paste, which is about 8 times higher than that obtainable by a conventional process. The inventive soybean paste is rich in vitamins, flavonoids, saponins or poly-phenols and may have anticancer and antioxidation activities.

The following Examples and Test Examples are given for the purpose of illustration only, and are not intended to limit the scope of the invention.

### REFERENCE EXAMPLE

### Preparation of Rice Koji using Aspergillus sp.

Polished rice(110.5 g) was soaked in water for 14 hrs and the soaked rice(204.8 g) was sterilized at 121 ° C. for 20 min, followed by steaming at 110° C. for 30 min. The steamed rice was allowed to cool to 37° C. and inoculated with 2 ml of shake-cultured Aspergillus orizae (KCTC 6983, Korean Gene Bank) (dry weight: 3.03 mg/ml). The inoculated rice was cultured under a relative humidity of 95% while varying the temperature stepwise as: 35° C. for 14 hrs, 33° C. for 9 hrs, 39° C. for 24 hrs, 42° C. for 15 hrs and 43° C. for 6 hrs, to obtain polished rice koji. The rice and Aspergillus orizae mixture was stirred well at each temperature step.

### Example 1

### Preparation of Soybean Hypocotyl Koji using Bacillus sp.

The procedure of Reference Example was repeated except that soybean hypocotyl(65 g) and 1.71 ml of Bacillus subtilis (KCTC 1028, Korean Gene Bank) (1.2×10⁹/ml) were used instead of polished rice and Aspergillus orizae (2 ml), respectively, to obtain soybean hypocotyl koji.

### Example 2

### Preparation of Soybean Hypocotyl Koji using Aspergillus sp.

The procedure of Reference Example was repeated except that soybean hypocotyl(300 g) was used instead of polished rice, to obtain soybean hypocotyl koji.

### Comparative Example 1

### Preparation of Soybean Koji using Bacillus sp.

The procedure of Example 1 was repeated except that soybean(65 g) was used in place of soybean hypocotyl, to obtain soybean koji.

### Comparative Example 2

### Preparation of Soybean Koji using Aspergillus sp.

The procedure of Example 2 was repeated except that soybean(300 g) was used instead of soybean hypocotyl to obtain soybean koji.

The soybean hypocotyl koji preparations obtained in Examples 1 and 2 as well as the soybean koji preparations obtained in Comparative Examples 1 and 2 were tested for their amylase, protease and β-glucosidase activities, as well as their isoflavone contents, as follows.

### Test Example 1

### Amylase Activity

Amylase activity was determined using the 3,5-dinitrosalicylic acid(DNS) method by measuring the absorbance of maltose produced by the action of amylase at 550 nm. The amount of enzyme that can produce a quantity of maltose equivalent to 1 umol/min of glucose is taken as 1 unit(1U) (K. H. Kang et al., Food Analytics, Sungkyunkwan Univ. Publishing Dept., 427(1998)), and the result is shown in Table I.

TABLE I

| | | |
|---|---|---|
| | Example | Comparative Example |
| Activation time | (unit/kg) | (unit/g) |

| (hrs) | 1 | 2 | 1 | 2 |
|---|---|---|---|---|
| 0 | 0 | 0 | 0 | 0 |
| 14 | 411 | 673 | 336 | 198 |
| 23 | 664 | 1,011 | 354 | 432 |
| 38 | 615 | 1,031 | 589 | 665 |
| 47 | 634 | 1,000 | 609 | 743 |
| 62 | 629 | 1,017 | 563 | 662 |
| 68 | 618 | 983 | 544 | 695 |

### Test Example 2

### Protease Activity

Protease activity was determined by measuring the absorbance of tyrosine produced from casein by the action of protease at 660 nm. The amount of enzyme that can produce a quantity of tyrosine equivalent to 1 umol/min of amino acid is taken as 1 unit(1U) (K. H. Kang et al., Food Analytics, Sungkyunkwan Univ. Publishing Dept., 427(1998)), and the result is shown in Table II.

TABLE II

| | | |
|---|---|---|
| | Example | Comparative Example |
| Activation time | (U/g) | (U/g) |

| (hrs) | 1 | 2 | 1 | 2 |
|---|---|---|---|---|
| 0 | 0 | 0 | 0 | 0 |
| 14 | 258 | 190 | 116 | 89 |
| 23 | 405 | 299 | 171 | 234 |
| 38 | 558 | 541 | 265 | 394 |
| 47 | 556 | 546 | 334 | 412 |
| 62 | 549 | 541 | 339 | 445 |
| 68 | 543 | 540 | 346 | 453 |

### Test Example 3

### β-Glucosidase Activity

The measurement of β-glucosidase activity of each koji sample was carried by measuring the absorbance at 405 nm using paranitrophenyl-α-D-glucopiranoside (PNPG) as a substrate. The amount of the enzyme that can release 1 umol/min of paranitrophenol from PNPG was taken as 1U(Kor. J. Appl. Microbio. Biotechnol., 25(2), 115-120(1997)), and the result is shown in Table III.

TABLE III

| | | |
|---|---|---|
| | Example | Comparative Example |
| Activation time | (unit/g) | (unit/g) |

| (hrs) | 1 | 2 | 1 | 2 |
|---|---|---|---|---|
| 0 | 0 | 0 | 0 | 0 |
| 14 | 0.38 | 0.07 | 0 | 0.033 |
| 23 | 0.59 | 2.1 | 0.106 | 0.360 |
| 38 | 39.0 | 4.0 | 0.245 | 2.750 |
| 47 | 47.13 | 39.6 | 0.368 | 0.875 |
| 62 | 45.88 | 81.5 | 0.499 | 0.826 |
| 68 | 47.75 | 87.1 | 0.572 | 0.572 |

The results in Table I, II and III demonstrate that the soybean hypocotyl koji preparations of Examples 1 and 2 have much higher amylase and protease activity than soybean koji preparations of Comparative Examples 1 and 2, and their β-glucosidase activities are particularly high, 32-83 times higher than the soybean koji preparations.

### Test Example 4

### pH Measurement

Variation is pH with the culture time were measured for each koji sample and the result is shown in Table IV.

TABLE IV

| | | |
|---|---|---|
| Activation time | Example | Comparative Example |

| (hrs) | 1 | 2 | 1 | 2 |
|---|---|---|---|---|
| 0 | 6.13 | 6.25 | 5.12 | 5.96 |
| 14 | 6.51 | 6.19 | 6.15 | 5.81 |
| 23 | 6.74 | 6.14 | 6.42 | 5.86 |
| 38 | 7.81 | 7.04 | 6.55 | 6.63 |
| 47 | 7.63 | 6.9 | 6.95 | 6.54 |
| 62 | 7.2 | 7.05 | 7.28 | 6.66 |
| 68 | 7.17 | 7.21 | 6.97 | 6.73 |

The result in Table IV suggests that pH gradually increases with culture time and that the initial pH is significantly higher for the soybean hypocotyl koji sample as compared with the soybean koji counterparts.

### Test Example 5

### Isoflavone Content

Total isoflavone and aglycone isoflavone contents were measured with high performance liquid chromatography(HPLC)(Shigemitsu K. et al., J. Biol. Chem., 55(9), 2227-2233(1991)). The result is shown in Table V.

<Measurement conditions of HPLC>

transfer phase: 15% and 35% of acetonitrile

column: YMC-Pack ODS-AM (AM-303)250×4.6 mm I.D./S-5 μM. 120A

wavelength: 260 nm

flow rate: 1.0 ml/min

operation time: 50 min

TABLE V

| | | Activation Time(hrs) | | | |
|---|---|---|---|---|---|
| Amount of isoflavone (mg/g) | | 0 | 23 | 47 | 68 |
| Example 1 | Total isoflavone | 11.80 | 11.23 | 11.9 | 11.94 |
| | Aglycone isoflavone | 2.64 | 6.65 | 7.32 | 10.57 |
| Example 2 | Total isoflavone | 11.65 | 11.50 | 11.71 | 12.03 |
| | Aglycone isoflavone | 2.55 | 2.88 | 3.28 | 7.05 |
| Comparative | Total isoflavone | 1.52 | 1.66 | 1.44 | 1.39 |
| Example 1 | Aglycone isoflavone | 0 | 1.21 | 1.44 | 1.39 |
| Comparative | Total isoflavone | 1.35 | 1.67 | 1.40 | 1.44 |
| Example 2 | Aglycone isoflavone | 0 | 0.27 | 0.55 | 1.44 |

As can be seen in Table V, both the total isoflavone and aglycone isoflavone contents of the soybean hypocotyl koji preparations of Examples 1 and 2 are much higher, as much as 8 times higher, than those of the soybean koji preparation obtained in Comparative Examples 1 and 2. In addition, the amount of the total isoflavone in each of the soybean hypocotyl koji samples is almost constant at 11-12 mg/g and does not vary with culture time, whereas the amount of aglycone isoflavone gradually increases with culture time. This suggests that some of the isoflavone is gradually converted to aglycone isoflavone while culturing.

### Example 3

### Preparation of a Soybean Hypocotyl Paste using a Koji Mixture

To a mixture composed of 51.0 wt % of the soybean hypocotyl koji of Example 1, 42.5 wt % of the rice koji of Reference Example and 6.5 wt %(21.5 g) of refined salt were mixed, 4 ml of sterile water and 2 ml (1×10¹⁰/ml) of Zygosaccharomyces rouxii (The Korean Gene Bank) were added, mixed uniformly, and cultured at 32° C. under a relative humidity of 75% for 50 days, to prepare a soybean hypocotyl paste.

### Comparative Example 3

### Preparation of a Soybean Paste using Soybean Koji

The procedure of Example 3 was repeated except that the soybean koji of Comparative Example 1 was used in place of the soybean hypocotyl koji of Example 1 to obtain a soybean paste.

### Test Example 6

### Nutrient Analysis

Nutrients of the soybean paste prepared in Example 3 were analyzed and compared with those of a commercial soybean paste.

TABLE VI

| | Crude | Crude | Carbohy | | |
|---|---|---|---|---|---|
| | protein | fatty acid | drate | Ash | Others |
| Ingredient | (wt %) | (wt %) | (wt %) | (wt %) | (wt %) |
| Soybean hypocotyl | 19.4 | 4.2 | 45.0 | 14.1 | 17.3 |
| koji of Example 3 | | | | | |
| Commercial | 28.0 | 10.0 | 28.6 | 29.6 | 3.8 |
| soybean paste | | | | | |

As can be seen in Table VI, the soybean hypocotyl paste prepared in Example 3 contains crude protein, crude fatty acid and ash in amounts less than those of a commercial soybean paste, while the carbohydrate content was higher.

### Example 4

### Preparation of a Soybean Hypocotyl Paste

The soybean hypocotyl koji prepared in Example 2 was mixed with refined salt in a weight ratio of 83.3:16.7, and 4 ml of distilled water and 2 ml (1×10¹⁰ pores/ml) of Zygosaccharomyces rouxii (KCTC, The Korean Gene Bank) were added thereto. After mixing uniformly, the mixture was fermented at 32° C., 75% relative humidity for 50 days, to obtain a soybean hypocotyl paste.

### Comparative Example 4

### Preparation of Soybean Paste

The procedure of Example 4 was repeated except that the soybean koji of Comparative Example 2 was used in place of the soybean hypocotyl koji.

### Example 5

### Preparation of a Japanese Soybean Hypocotyl Paste (Miso)

A mixture of 56.1 parts by weight of the polished rice koji of Reference Example, 33.0 parts by weight of steamed (110° C., 30 min) soybean hypocotyl and 10.9 parts by weight of refined salt was subjected to the same method described in Example 3, to obtain a Japanese soybean paste.

### Comparative Example 5

### Preparation of a Soybean Paste

A mixture of 56.1 parts by weight of the polished rice koji of Reference Example, 33.0 parts by weight of steamed (110° C., 30 min) soybean and 10.9 parts by weight of refined salt was subjected to the same method described in Example 3, to obtain a soybean paste.

### Test Example 7

### Isoflavone Content

Isoflavone contents of the soybean pastes prepared in Examples 3-5 and Comparative Examples 3-5 were measured according to the procedure of Test Example 5. The result is shown in Table VII.

TABLE VII

| | | Cultivation time (days) | | | | | | | | |
|---|---|---|---|---|---|---|---|---|---|---|
| | | 1 | 3 | 7 | 9 | 11 | 21 | 33 | 38 | 46 |
| Example | 3 | 4.81 | 4.76 | 4.72 | 5.14 | 5.17 | 5.37 | 5.15 | 5.21 | 5.14 |
| (mg/g) | 4 | 10.6 | 10.6 | 11.0 | 11.25 | 12.0 | 12.1 | — | — | — |
| | 5 | — | 5.14 | 4.97 | 5.44 | 5.30 | 5.61 | — | — | 5.24 |
| Comparative | 3 | — | 0.30 | — | 0.27 | 0.26 | 0.28 | 0.26 | 0.26 | 0.31 |
| Example | 4 | 1.15 | 1.12 | 1.06 | 1.15 | 1.17 | 1.20 | — | — | — |
| (mg/g) | 5 | 0.38 | — | — | 0.32 | — | 0.28 | — | — | — |

As can be seen in Table VII, the isoflavone contents of the soybean hypocotyl pastes prepared in Examples 3-5 are much higher as compared with the soybean pastes of Comparative Examples 3-5.

### Test Example 8

### Content of Aglycone Isoflavone

Aglycone isoflavone contens of the soybean pastes of Examples 3-5 and Comparative Examples 3-5 were measured according to the procedure of Test Example 5. The result is shown in Table VIII.

TABLE VIII
Cultivation time (days)

| | | 1 | 3 | 7 | 9 | 11 | 21 | 33 | 38 | 46 |
|---|---|---|---|---|---|---|---|---|---|---|
| Example | 3 | 4.81 | 4.76 | 4.72 | 5.14 | 5.17 | 5.37 | 5.15 | 5.21 | 5.14 |
| (mg/g) | 4 | 4.64 | 4.64 | 4.90 | 5.11 | 5.70 | 6.21 | — | — | — |
| | 5 | — | 1.98 | 3.22 | 3.78 | 3.72 | 4.19 | — | — | 4.14 |
| Comparative | 3 | — | 0.30 | — | 0.27 | 0.26 | 0.28 | 0.26 | 0.26 | 0.31 |
| Example | 4 | 0.73 | 0.73 | 0.71 | 0.81 | 0.87 | 0.94 | — | — | — |
| (mg/g) | 5 | 0 | — | — | 0.32 | — | 0.28 | — | — | — |

The result shown in VIII demonstrates that the aglycone isoflavone contents of the soybean hypocotyl pastes prepared in Examples 3-5 are about 8 times higher as compared with those of the soybean pastes.

### Example 6

### Preparation of a Pepper Soypaste using Soybean Hypocotyl Koji

83.5 g of the soybean hypocotyl koji prepared in Example 1 and 30 g of the polished rice koji prepared in Reference Example, were mixed and combined with 80 g of steamed(110° C., 50 min.) wheat flour, 27.5 g of powdered red pepper, 25 g of refined salt, 80 ml of distilled water and 5 ml of Zygosaccharomyces rouxii. The resulting mixture was soaked and cultivated at a relative humidity of 75% and a temperature of 25° C. for 60 days, to obtain a pepper soypaste.

### Comparative Example 6

### Preparation of a Pepper Soypaste using Soybean Koji

The procedure of Example 6 was repeated except that 83.5 g of soybean koji was used in place of soybean hypocotyl koji, to obtain a pepper soypaste.

### Test Example 9

### Isoflavone Content

Isoflavone contents of the pepper soypastes of Example 6 and Comparative Example 6 were measured according to the procedure of Test Example 5. The result is shown in Table IX.

TABLE IX

| | | Cultivation time (days) | | | | |
|---|---|---|---|---|---|---|
| | | 0 | 14 | 29 | 45 | 60 |
| Example 6 | Total amount of | 2.76 | 2.79 | 2.92 | 2.80 | 2.84 |
| | Isoflavone (mg/g) | | | | | |
| | Amount of aglycone | 2.76 | 2.79 | 2.92 | 2.80 | 2.84 |
| | Isoflavone (mg/g) | | | | | |

| | | | | | |
|---|---|---|---|---|---|
| Comparative Example 6 (mg/g) | t | t | t | t | t |
| ※ t (trace): below 0.05 mg/g | | | | | |

As can be seen in Table IX, the isoflavone of the soybean hypocotyl-derived pepper soypaste prepared in Example 6 is entirely in the form of the aglycone type and it does not fluctuate with cultivation time. In contrast, the isoflavone content of the soybean-derived pepper soypaste was practically nil.

### Example 7

### Preparation of a Soy Sauce

1 kg of the soybean hypocotyl koji prepared in Example 2 was dried in a hot-air dryer at 65° C. for 24 hrs, soaked in 3 L of 18% brine and cultivated at room temperature for 30 days (pre-cultivation), followed by transferring into a new clean vessel and re-cultivating for 30 days (secondary cultivation), to obtain soybean hypocotyl soysauce.

### Test Example 10

### Enzyme activity of Soybean Hypocotyl-Derived Soy Sauce

Amylase, protease and β-glucosidase activities of the soy sauce prepared in Example 7 were measured by the methods of Test Examples 1-3. The result is shown in Table X.

TABLE X

| | | Enzyme Activity | | |
|---|---|---|---|---|
| | | Amylase | Protease | β-glucosidase |
| Cultivation time | | (unit/ml) | (unit/ml) | (unit/ml) |
| Pre- | 15 days | 2,442 | 345 | 151 |
| cultivation | 30 days | 2,708 | 340 | 163 |
| 2^{nd} | 15 days | 2,254 | 336 | 149 |
| Cultivation | 30 days | 2,221 | 317 | 148 |

### Test Example 11

### Isoflavone Content of the Soybean Hypocotyl-Derived Soy Sauce

Total isoflavone and aglycone isoflavone contents of the soy sauce prepared in Example 7 were measured according to the procedure of Test Example 5. The result is shown in Table XI.

TABLE XI

| Cultivation time | | Total Isoflavone | Aglycone Isoflavone |
|---|---|---|---|
| (days) | | Content (ug/ml) | Content (ug/ml) |
| Pre-cultivation | 15 days | 163 | 24.1 |
| | 30 days | 174 | 24.3 |

The total isoflavone content increases slightly with culture time while the aglycone isoflavone content remains constant. This suggests that water-soluble glycosidic isoflavone dissolved in soy sauce does not undergo further conversion into aglycone isoflavone.

### Test Example 12

### Free and Total Amino Acid Contents of the Soybean Hypocotyl-Derived Soy Sauce

Amino acids in the soy sauce prepared in Example 7 and those in a commercial soy sauce (Daehwan Food Inc.) were analyzed by the PICO-tag method. The result is shown in Table XII.

TABLE XII

Content (%)

| | Example 7 | | Conventional soy sauce | |
|---|---|---|---|---|
| Amino Acid | Free | Total | Free | Total |
| Cys | 1.78 | 0.48 | 1.11 | 1.06 |
| Asp | 7.54 | 11.62 | 1.57 | 6.88 |
| Glu | 14.42 | 19.50 | 19.22 | 24.93 |
| Ser | 7.18 | 7.08 | 6.75 | 6.50 |
| Gly | 4.89 | 8.81 | 5.25 | 8.78 |
| His | 2.65 | 3.17 | 0.68 | 0.94 |
| Arg | 3.45 | 3.02 | 0.29 | 0.89 |
| Thr | 5.72 | 6.59 | 5.09 | 5.27 |
| Ala | 8.58 | 9.54 | 15.54 | 14.53 |
| Pro | 6.22 | 0.1 | 5.53 | 0.07 |
| Tyr | 2.94 | 1.51 | 0.36 | 0.36 |
| Var | 7.27 | 6.07 | 7.31 | 6.01 |
| Met | 2.38 | 1.22 | 1.66 | 1.22 |
| Cys2 | 0.60 | 0.10 | 0.10 | 0.03 |
| Ile | 5.43 | 5.01 | 6.37 | 5.38 |
| Leu | 8.10 | 6.35 | 9.60 | 7.33 |
| Phe | 3.32 | 2.77 | 4.64 | 3.43 |
| Trp | 0.94 | 0.13 | 1.30 | 0.12 |
| Lys | 6.59 | 6.93 | 7.63 | 6.27 |

The result in Table XII demonstrates that the soybean hypocotyl sauce obtained in Example 7 has an arginine content which is 11.9 times higher than that of the commercial soy sauce (arginine is known to be effective in preventing the growth and metastasis of tumor or cancer cells). Further, the soybean hypocotyl sauce of the present invention has 8.2 times higher tyrosine content (tyrosine functions in degrading body fat and suppresses appetite); a 4.8 times higher aspartic acid content (aspartic acid has potent hepatoprotectic acitivity); and a 4.0 times higher histidine content (histidine is essential in the treatment of allergy, rheumatic arthritis and anemia and in the production of blood cells), as compared with the commercial soy sauce.

### Example 8

### Preparation of a Soybean Paste using Koji Residue

The koji residue produced as a byproduct in the preparation of the soy hypocotyl sauce of Example 7 was transferred into a clean vessel and cultivated at room temperature for 30 days, to prepare a soybean hypocotyl paste.

### Test Example 13

### Enzyme Activity

Amylase, protease and β-glucosidase activities of the soybean paste prepared in Example 8 were measured by the methods of Test Examples 1-3 and the result is shown in Table XIII.

TABLE XIII

| | | Enzyme Activity | | |
|---|---|---|---|---|
| | | amylase | protease | β-glucosidase |
| Cultivation time (days) | | (unit/ml) | (unit/ml) | (unit/ml) |
| Pre- | 15 | 5,238 | 528 | 321 |
| cultivation | 30 | 4,875 | 502 | 359 |
| 2^{nd} | 15 | 4,841 | 482 | 308 |
| Cultivation | 30 | 4,563 | 501 | 310 |

### Test Example 14

### Isoflavone Content

Total isoflavone and aglycone isoflavone contents of the soybean paste prepared in Example 8 were measured by the method in Test Example 5. The result is shown in Table XIV.

TABLE XIV

| | | Total Isoflavone | Aglycone Isoflavone |
|---|---|---|---|
| Cultivation time (days) | | Content (mg/g) | Content (mg/g) |
| Pre-cultivation | 15 | 15.04 | 11.51 |
| | 30 | 15.15 | 11.96 |
| 2^{nd} Cultivation | 15 | 13.98 | 13.98 |
| | 30 | 14.30 | 14.30 |

As in Table XIV, a large amount of isoflavone was produced during the preparation of the soybean paste using soybean hypocotyl koji residue and all isoflavone was converted into aglycone isoflavone during the 2^{nd} cultivation.

Thus, The soybean hypocotyl koji of the present invention has much higher isoflavone and aglycone isoflavone contents as well as high amylase and protease activities as compared with the conventional koji. Therefore, it can be advantageously used in the preparation of fermented soy hypocotyl products such as soy sauce, soybean paste and pepper soypaste.

While the invention has been described with respect to the above specific embodiments, it should be recognized that various modifications and changes may be made to the invention by those skilled in the art which also fall within the scope of the invention as defined by the appended claims.

What is claimed is:

1. A method for producing koji comprising culturing soybean hypocotyl inoculated with a microorganism.

2. The method of claim 1, wherein the microorganism is Bacillus sp., Aspergilllus sp. or a mixture thereof used in an amount of 0.01 to 10 wt % based on the weight of the soybean hypocotyl.

3. The method of claim 1, which comprises:
(a) soaking the soybean hypocotyl in water for a period ranging from 1 min to 30 hrs;
(b) steaming the soaked soybean hypocotyl at a temperature ranging from 90 to 140° C.;
(c) inoculating the steamed soybean hypocotyl with Bacillus sp., Aspergilllus sp. or a mixture thereof in an amount ranging from 0.01 to 10 wt % based on the weight of the soybean hypocotyl; and
(d) culturing the inoculated soybean hypocotyl at a temperature ranging from 15 to 55° C., a relative humidity ranging from 40 to 100% and at a pH ranging from 3 to 10 for a period ranging from 1 to 8 days.

4. The method of claim 3, wherein step (a) is carried out for 1 to 30 min.

5. The method of claim 3, wherein step (d) is carried out at 25 to 35° C.

6. The method of claim 3, wherein step (d) is carried out in 2 steps of pre-culturing and culturing, and each of the pre-culturing and culturing step is carried out for 12 to 72 hrs.

7. The method of claim 2, wherein the Basillus sp. is selected from the group consisting of Bacillus brevis, Bacillus licheniformis, Bacillus natto, Bacillus polymixa, Bacillus pumilis, Bacillus subtilis and a mixture thereof; and the Aspergillus sp. is selected from the group consisting of Aspergillus awamori, Aspergillus kawachii, Aspergillus niger, Aspergillus oryzae, Aspergillus shirousamii, Aspergillus sojae, Aspergillus tamarii and a mixture thereof.

8. The soybean hypocotyl koji produced by any of the methods of claims 1 to 7.

9. The soybean hypocotyl koji of claim 8, which contains soybean hypocotyl in an amount of 5 to 100 wt % based on the weight of the koji.

10. A method for producing a fermented soy hypocotyl product, which comprises using the soybean hypocotyl koji of claim 8 as a raw material.

11. The method of claim 10, wherein the fermented soy hypocotyl product contains the soybean hypocotyl koji in an amount of 5 to 97 wt % based on the weight of the soy hypocotyl product.

12. The method of claim 10, wherein the cultivation is carried out in the presence of added yeast, lactic acid bacteria or a mixture thereof, the amount of the additive being 0.01 to 10 wt % based on the total weight of the product.

13. The method of claim 12, wherein the yeast is selected from the group consisting of Saccharomyces rouxii, Torulopsis dattila, Torulopsis etcbellsii, Torulopsis versatilis and Zygosaccharomyces rouxii, and the lactic acid bacteria is selected from the group consisting of Pediococcus halphilus, Pediococcus sojae and Tetracoccus sojae.

14. The method of claim 10, wherein starch koji is added as a supplementary koji substrate.

15. The method of claim 14, wherein the soybean hypocotyl koji and the starch koji are used in the respective amounts of 5 to 97 wt % and 1 to 95 wt % based on the total weight of the soybean paste.

16. The fermented soy hypocotyl product prepared by any of the methods of claims 10 to 15.

17. The fermented soy product of claim 16, which is a soybean paste, a pepper soypaste or a soy sauce.

18. The food product of claim 16, comprising isoflavone in an amount of 0.1 to 3 wt %.
